(19) United States
(12) Patent Application Publication
(10) Pub. No.: US 2019/0287702 A1
(43) Pub. Date: Sep. 19, 2019

(54) Multi-Layered Component and Method for Producing a Multi-Layered Component

(71) Applicant: TDK Electronics AG, München (DE)

(72) Inventors: Thomas Feichtinger, Graz (AT); Bernhard Döllgast, Deutschlandsberg (AT)

(21) Appl. No.: 16/300,533

(22) PCT Filed: May 5, 2017
(86) PCT No.: PCT/EP2017/060783

§ 371 Date: Nov. 9, 2018

(30) Foreign Application Priority Data
May 10, 2016 (DE) 10 2016 108 604.5

(51) Int. Cl. H01C 7/18; H01C 1/02; H01C 1/14; H01C 17/20; H01C 7/12; H01C 7/04

(52) U.S. Cl. CPC H01C 7/18; H01C 1/02; H01C 7/041; H01C 17/20; H01C 7/12; H01C 1/14

(57) ABSTRACT

A multi-layered component and a method for producing a multi-layered component are disclosed. In an embodiment a multi-layered component includes an inert ceramic substrate and at least one functional ceramic, wherein the functional ceramic is completely enclosed by the ceramic substrate.

This patent application is a national phase filing under section 371 of PCT/EP2017/060783, filed May 5, 2017, which claims the priority of German patent application 10 2016 108 604.5, filed May 10, 2016, each of which is incorporated herein by reference in its entirety.

### TECHNICAL FIELD

The present invention relates to a ceramic multi-layered component. The invention furthermore relates to a method for producing a ceramic multi-layered component.

### BACKGROUND

For integrating functionalities into multi-layered components, it is known, for example, to integrate a completely enclosed electroceramic or functional ceramic into an inert organic material. It is also known to construct a carrier from a functional ceramic itself, such as a varistor ceramic, for example. However, additional surface layers, for example, composed of glass or polymer, are required in this case in order to protect the functional ceramic against external influences.

### SUMMARY OF THE INVENTION

Embodiments provide an improved multi-layered component and a method for producing an improved multi-layered component.

In accordance with one aspect, a multi-layered component is specified. The multi-layered component comprises an inert ceramic substrate. In this context, “inert” is understood to mean that a surface of the ceramic substrate has a high insulation resistance. The high insulation resistance protects the surface of the substrate against external influences. The high insulation resistance makes the surface insensitive to electrochemical processes, for example, such as the deposition of metallic layers on the surface. The high insulation resistance furthermore makes the surface of the substrate insensitive to aggressive media, e.g., aggressive fluxes that are used during soldering processes, for example.

The multi-layered component comprises at least one functional ceramic. The multi-layered component can also comprise more than one functional ceramic. By way of example, the multi-layered component comprises two, three, five, ten or more functional ceramics. The functional ceramic serves to provide specific functionalities of the multi-layered component. The functional ceramic serves to integrate the specific functions into the substrate. In this case, different functional ceramics can make available different but also identical functionalities.

The ceramic substrate serves as a carrier for the functional ceramic. The functional ceramic is completely enclosed by the ceramic substrate. In other words, the functional ceramic is surrounded toward all sides by the inert, dielectric ceramic material of the substrate. The functional ceramic has specific properties, for example, a defined shape and size, in order to integrate the functional ceramic into the ceramic substrate. By way of example the functional ceramic is configured in granular, spherical, disk-shaped, elliptical or cubic fashion. By way of example, the functional ceramic has a diameter of less than or equal to 100 μm, for example, 50 μm.

The ceramic substrate has specific properties in order to integrate the functional ceramic into the substrate. In this regard, a cutout is provided in an inner region of the substrate, the functional ceramic being introduced into said cutout during the production of the multi-layered component. The functional ceramic is completely arranged in the inner region of the substrate.

By virtue of the inert, dielectric, ceramic substrate, the functional ceramic is protected against harmful external influences. A compact, stable, long-lived and adaptive multi-layered component can be provided in this way.

In accordance with one exemplary embodiment, the ceramic substrate comprises an LTCC (low temperature cofired ceramics) ceramic. LTCC technology makes it possible to realize ceramic multi-layered components with a plurality of metallization planes, into which a multiplicity of passive component parts such as conductor tracks, resistances, capacitances and inductances can be integrated. The LTCC ceramic preferably has a low dielectric constant. Undesired parasitic electrical effects, such as parasitic capacitances of the substrate, can thus be suppressed.

In accordance with one exemplary embodiment, the multi-layered component comprises a multiplicity of functional ceramics. The functional ceramics have different properties. The functional ceramics have different coefficients of expansion and/or different sintering temperatures, for example. As a result of the complete embedding of the functional ceramics into the inert dielectric ceramic material of the substrate, the different properties of the functional ceramics can be compensated for. A wide variety of functionalities can thus be integrated. Extremely adaptive and flexibly usable multi-layered components can thus be realized.

In accordance with one exemplary embodiment, the at least one functional ceramic comprises an HTCC ceramic. In the case of HTCC ceramics, the sintering temperatures are significantly above 1000® C, for example, 1500° C. The grain structure of the HTCC ceramic is not influenced by the processing (firing) of the LTCC ceramic of the substrate at temperatures significantly below 1000® C. The functionality of the functional ceramic in the substrate is thus maintained even after the firing of the LTCC ceramic.

In accordance with one exemplary embodiment, the functional ceramic comprises a varistor, an NTC (negative temperature coefficient) ceramic, a PTC (positive temperature coefficient) ceramic or a ferrite. By way of example, the functional ceramic is configured as an ESD protection element. Consequently, different functionalities of the multi-layered component can be provided by the functional ceramic.

In accordance with a further aspect, a method for producing a multi-layered component is described. The multi-layered component described above is preferably produced by the method. All features that have been described in association with the multi-layered component also find application for the method, and vice versa.

A first step involves producing at least one functional ceramic, preferably a plurality of functional ceramics. In this case, functional ceramics having different functionalities can be produced. The respective functional ceramic is based on ceramic spray granules, a ceramic powder and/or ceramic green layers. The spray granules, the ceramic powder and/or the green layers are sieved, pressed and sintered. The functional ceramic is sintered at temperatures of greater than or equal to 1000® C, for example, 1300° C. or 1500° C., during this production process. The functional ceramic can obtain a wide variety of geometric shapes during production. By way of example, the functional ceramic can comprise a sintered grain, a sintered sphere, a sintered chip or a sintered cube.

A further step involves providing LTCC green sheets having at least one cutout. The green layers are stacked one above another. The cutout is provided by stamping or laser treating the green sheets and completely penetrates through the green sheets provided.

A further step involves providing, for example, printing, electrode structures on at least one portion of the green sheets. The electrode structures comprise silver and/or palladium, for example. The electrode structures are preferably applied before the green sheets provided are stacked.

A further step involves introducing the functional ceramic into the cutout. In particular, the cutout is equipped with the functional ceramic and the functional ceramic is shaken into the cutout with an accurate fit.

A further step involves providing ceramic cover sheets in the green state. The latter are arranged at the top side and the underside of the stack composed of green sheets. The cover sheets are free of the cutout, such that the functional ceramic is surrounded by ceramic material from all sides.

A further step involves laminating and pressing the green sheets and the cover sheets to form a green stack.

In a further step, further cutouts for producing plated-through holes can optionally be introduced into the green stack by means of stamping or laser processes. These cutouts completely penetrate through the green stack. The cutouts are arranged in a region of the green stack which is spatially separated from that region in which the functional ceramic is arranged.

A further step involves sintering the green stack. The green stack is sintered at a temperature which is, for example, 150° C. below the sintering temperature of the functional ceramic. As a result, the functionality of the integrated functional ceramic is not influenced by the sintering of the green stack. Through a suitable choice of the LTCC ceramic with defined sintering shrinkage in the z-direction and little shrinkage in the x- and y-directions, this results in the functional ceramic being enclosed by the ceramic substrate in a manner free of cracks. In this case, the ceramic material of the substrate can bear against the functional ceramic with an accurate fit. As an alternative thereto, after the sintering of the green stack, a gap can also remain between the functional ceramic and the material of the ceramic substrate.

A last step involves providing external contacts at outer surfaces of the sintered green stack. By way of example, a silver paste is applied on the end side of the sintered green stack and then fired.

The multi-layered component produced thereby comprises at least one functional ceramic which is integrated completely into the ceramic substrate. As a result of the embedding of the functional ceramic into the inert, dielectric ceramic material, the multi-layered component can be exposed to harsh ambient conditions (high temperatures, aggressive media) without the functional ceramic incurring damage. As a result of the low dielectric constant of the ceramic substrate, the multi-layered component can furthermore be used in applications in which reducing undesired parasitic electrical effects (for example, the parasitic capacitance) of the substrate is of importance. A long-lived and adaptive multi-layered component is thus provided.

### BRIEF DESCRIPTION OF THE DRAWINGS

The drawings described below should not be interpreted as true to scale. Rather, individual dimensions may be illustrated as enlarged, reduced or even distorted for the sake of better illustration.

Elements which are identical to one another or which perform the same function are designated by identical reference signs.

In the figures:

FIG. 1 shows a schematic illustration of a multi-layered component;

FIG. 2 shows a sectional illustration of a multi-layered component in accordance with a first exemplary embodiment;

FIG. 3 shows a sectional illustration of a multi-layered component in accordance with a second exemplary embodiment;

FIG. 4 shows a horizontal sectional view of the multi-layered component in accordance with FIG. 3;

FIG. 5 shows a horizontal sectional view of the multi-layered component in accordance with FIG. 3 in accordance with a further exemplary embodiment;

FIG. 6 shows a sectional illustration of a multi-layered component in accordance with a third exemplary embodiment;

FIG. 7 shows a sectional illustration of a multi-layered component in accordance with a fourth exemplary embodiment;

FIG. 8a shows one method step in the production of a multi-layered component;

FIG. 8b shows a further method step in the production of a multi-layered component;

FIG. 8c shows a further method step in the production of a multi-layered component; and

FIG. 8d shows a further method step in the production of a multi-layered component.

### DETAILED DESCRIPTION OF ILLUSTRATIVE EMBODIMENTS

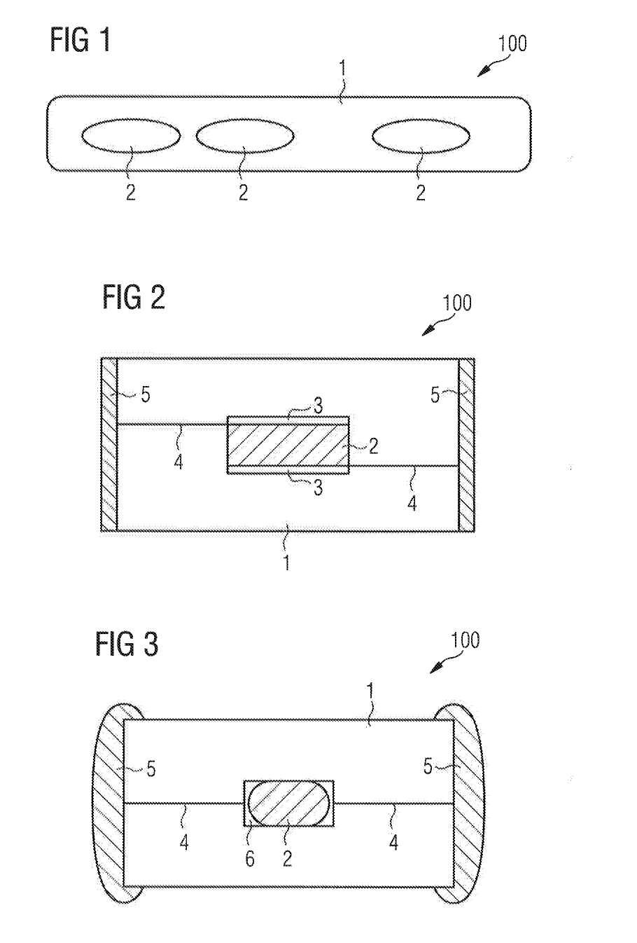

FIG. 1 shows a schematic illustration of a multi-layered component 100. The multi-layered component 100 comprises a substrate 1. The substrate 1 preferably comprises an inert dielectric ceramic carrier. In this context, “inert” is understood to mean that a surface of the substrate 1 has a high insulation resistance. The high insulation resistance makes the surface of the substrate 1 insensitive to electrochemical processes, such as, for example, the deposition of metallic layers, e.g., layers comprising Ni, Z, Ag or Ad, on the surface of the substrate 1. The high insulation resistance furthermore makes the surface of substrate 1 insensitive to aggressive media, such as, for example, aggressive fluxes that are used in soldering processes, for example. Said aggressive media can attack the surface and lead to undesired side effects, such as short circuits and creepage currents.

The substrate 1 is preferably a multi-layered ceramic. The substrate 1 preferably comprises an LTCC ceramic. Particularly preferably, the substrate 1 comprises a glass ceramic.

The multi-layered component 100 furthermore comprises a multiplicity of functional ceramics 2, for example, two, three, five or 10 functional ceramics 2. The functional ceramics 2 are arranged within the substrate 1. The functional ceramics 2 are completely enclosed by the substrate 1. The functional ceramics 2 are spatially separated and electrically insulated from one another.

Preferably, the respective functional ceramic 2 comprises a HTCC ceramic. The respective functional ceramic 2 can comprise ZnO—Pr (varistor), MnMiX (NTC ceramic), BaTiO₃ (PTC ceramic) or a ferrite, depending on the desired function and manner of operation of the respective functional ceramic 2. In this case, a plurality of functional ceramics 2 can also have the same composition. As an alternative thereto, each functional ceramic 2 can also be configured differently in order to realize different desired functions within the substrate 1.

By virtue of the inert surface of the substrate 1, the functional ceramics 2 are protected against external influences. Additional surface protection layers for the functional ceramics, such as glass or polymer layers, for example, are thus superfluous.

FIG. 2 shows a sectional illustration of a multi-layered component 100 in accordance with a first exemplary embodiment. In particular, FIG. 2 illustrates a multi-layered component 100 comprising a ceramic substrate 1 and an integrated disk-type varistor as functional ceramic 2. The functional ceramic 2 preferably comprises a plastic molded varistor such as, for example, an SMD CU varistor or a ThermoFuse varistor.

The functional ceramic 2 is configured in disk-shaped fashion. The functional ceramic 2 preferably comprises a metal disk. The functional ceramic is a disk-type varistor. By way of example, the functional ceramic comprises ZnO—Pr.

The substrate 1 comprises internal electrodes 4. The internal electrodes 4 are arranged between ceramic layers (not explicitly illustrated) of the substrate 1. The internal electrodes 4 serve for electrically contacting the functional ceramic 2. The functional ceramic 2 is arranged in a cutout 6 (not explicitly illustrated here) in the inner region of the substrate 1. The internal electrodes 4 extend as far as the edge of said cutout 6 in order to electrically contact the functional ceramic 2.

The functional ceramic 2 comprises external contacts 3. The external contacts 3 are formed at outer surfaces, here the top side and underside, of the functional ceramic 2. By way of example, the external contacts 3 are metal layers at the top side and underside of the functional ceramic 2. The internal electrodes 4 are electrically conductively connected to the external contacts 3.

Furthermore, external electrodes 5 are arranged at the opposite side surfaces of the substrate 1 for electrically contacting the multi-layered component 100. The external electrodes 5 are electrically connected alternately to internal electrodes 4 of a different polarity.

The multi-layered component 100 illustrated in FIG. 2 is configured for high-temperature applications at ≥150° C. The substrate 1, which completely surrounds the functional ceramic 2, in this case protects the functional ceramic 2 against the high temperatures that occur. In particular, the inert surface of the substrate 1 serves to protect the integrated disk-type varistor, which is specified for maximum use temperatures of up to 85° C., against the high temperatures.

FIG. 3 shows a sectional illustration of a multi-layered component 100 in accordance with a second exemplary embodiment. In particular, FIG. 3 illustrates a multi-layered component 100 comprising an integrated SMD (surface mounted device) varistor having a low clamping voltage and capacitance as functional ceramic 2. The clamping voltage occurs during an ESD event together with a specific surge current at the component. The higher the clamping voltage that occurs at the varistor for the same current, the greater, too, the electrical power and thus ultimately the energy that has to be absorbed by the varistor. At lower clamping voltages, therefore, a higher current-carrying capacity is achieved in order to obtain the same energy absorption.

The multi-layered component 100 comprises the substrate 1 described above. The functional ceramic 2 is arranged or embedded into a cutout 6 within the substrate 1. The cutout 6 makes it possible to introduce the functional ceramic 2 into the substrate 1 during the production process. By way of example, the cutout 6 has a sintered via or a sintered plated-through hole for individual layers of the substrate 1. The cutout 6 is distinguished in particular by the fact that it does not completely penetrate through the substrate 1. The functional ceramic 2 embedded in the cutout 6 is thus surrounded by the material of the substrate 1 from all sides, i.e., completely.

Depending on the requirements made of the multi-layered component 100, the cutout 6 and/or the functional ceramic 2 can be configured such that the functional ceramic 2 is enclosed by the substrate 1 in such a way that no gap remains between the material of the substrate 1 and the functional ceramic 2 (see FIG. 2). As an alternative thereto, however, the cutout 6 can also be configured such that a gap remains between the functional ceramic 2 and the material of the substrate 1 (see FIG. 3), that is to say that the cutout 6 is also visible after the multi-layered component 100 has been completed. This may be necessary particularly if the material of functional ceramic 2 and substrate 1 has different coefficients of expansion, in order to avoid cracks or damage of the multi-layered component 100 during further processing, for example, during soldering.

The functional ceramic 2 is configured in spherical fashion in this exemplary embodiment. The functional ceramic 2 preferably comprises a varistor sphere. The functional ceramic 2 comprises ZnO—PrCo, for example. Preferably, the functional ceramic 2 is a sintered ZnO—PrCo grain. The functional ceramic 2 has a low capacitance. By way of example, the capacitance of the functional ceramic is 0.5 pF or less, for example, 0.47 pF. The functional ceramic 2 has a diameter of less than 100 μm, preferably less than or equal to 50 μm. The functional ceramic preferably has a specific electric field strength Ev=500 V/mm. The dielectric constant epsilon of the functional ceramic 2 is high. By way of example, eps=400.

By contrast, the substrate 1 has a very low dielectric constant epsilon. By way of example, the dielectric constant of the substrate is less than 50, preferably less than 10. Preferably, eps=7 or eps=7.5. The low dielectric constant of the surrounding substrate 1 serves to suppress the parasitic capacitance of the substrate 1. By way of example, the parasitic capacitance of the substrate 1 is 0.47 pF below the parasitic capacitance of a standard carrier substrate where eps=400 in accordance with the prior art.

The substrate 1 furthermore comprises the internal electrodes 4 already mentioned in association with FIG. 2. Finally, the external electrodes 5 are arranged at the opposite side surfaces of the substrate 1 for electrically contacting the multi-layered component 100.

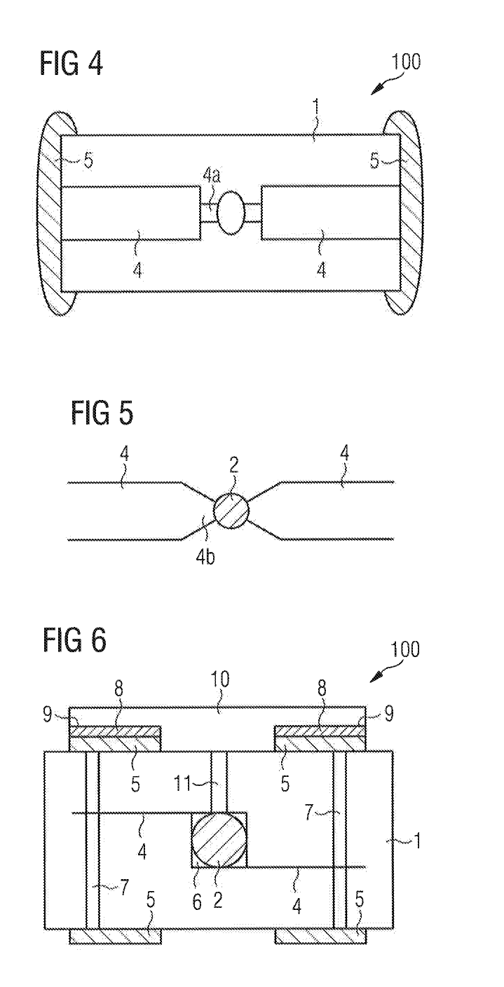

The internal electrodes 4 serve for electrically contacting the functional ceramic 2 and extend as far as the edge of the cutout 6 in order to electrically contact the functional ceramic 2. Depending on the configuration of the functional ceramic, the respective internal electrode 4 can be shaped differently (in this respect, see FIGS. 4 and 5). By way of example, the respective internal electrode 4 can have a constriction 4b (FIG. 5) in the region of the feed to the functional ceramic. This is advantageous particularly if the functional ceramic 2 is configured in spherical fashion. In particular, the respective internal electrode 4 can be electrically connected to the functional ceramic 2 in a targeted and accurate manner by means of the constriction 4b. As an alternative thereto, the respective internal electrode 4 can have a web 4a or web-shaped connection region for electrically contacting the functional ceramic 2 (FIG. 4). This is advantageous, for example, if the functional ceramic 2 has a larger horizontal extent, that is to say is configured in elliptical fashion, for example. However, other configurations of the internal electrode 4 for connecting the functional ceramic 2 are also conceivable.

FIG. 6 shows a sectional illustration of a multi-layered component 100 in accordance with a third exemplary embodiment. In particular, FIG. 6 illustrates a multi-layered component 100 in the form of an LED carrier with integrated ESD protection. Only the differences with respect to the multi-layered component 100 described in association with FIGS. 2 to 5 are described below.

The multi-layered component 100 comprises a heat source 10, for example, an LED. The heat source 10 is electrically conductively connected to the external contacts 5 of the substrate 1 by way of contact pads 9 at the underside of the heat source 10, for example, an electrically conductive metallic layer. In this exemplary embodiment, the respective external contact 5 is arranged at the top side of the substrate 1 and connected to the respective contact pad 9 by way of a solder connection 8.

The substrate 1 has vias or plated-through holes 7. The respective plated-through hole 7 completely penetrates through the substrate 1 in the vertical direction. At the top side of the substrate 1, the respective plated-through hole 7 is electrically conductively connected to a respective external contact 5. Further external electrodes 5 are arranged at the underside of the substrate 1, said further external electrodes being electrically conductively connected to the respective plated-through hole 7. In this exemplary embodiment, the internal electrodes 4 do not extend as far as the side surfaces of the substrate 1, but rather are electrically conductively connected to the plated-through holes 7.

The substrate 1 can furthermore have a thermal contact 11, for example, for a temperature sensor. The thermal contact 11 can comprise, for example, a via filled with metal.

The functional ceramic 2 is, for example, configured in spherical fashion, sintered, and introduced into the cutout 6 within the substrate 1, such that the functional ceramic 2 is completely surrounded by the material of the substrate 1 from all sides. In this exemplary embodiment, the functional ceramic 2 serves as an ESD protection structure. The functional ceramic 2 is a varistor chip. The heat source 10, which is very sensitive to overvoltages, such as can be triggered, e.g., by an ESD pulse, is effectively protected against these current or voltage surges with the aid of the functional ceramic 2.

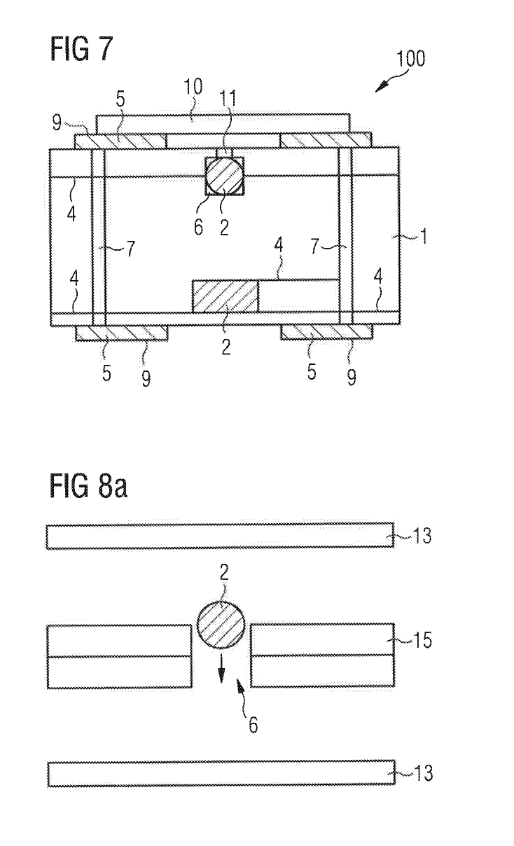

FIG. 7 shows a sectional illustration of a multi-layered component 100 in accordance with a fourth exemplary embodiment. In particular, FIG. 7 illustrates a multi-layered component 100 in the form of an LED carrier with integrated ESD protection and temperature sensor.

Only the differences with respect to the multi-layered component 100 described in association with FIG. 6 are described below. In addition to the multi-layered component 100 from FIG. 6, a second functional ceramic 2 is embedded in the substrate 1. The two functional ceramics 2 are spatially separated from one another and in each case completely surrounded by the material of the substrate 1.

A first functional ceramic 2, which is illustrated in the lower region of the substrate 1 in FIG. 7, in this case serves as an ESD structure and protects the heat source 10, for example, an LED, against overvoltages. The first functional ceramic 2 is configured as a varistor chip.

A second functional ceramic 2, which is illustrated in the upper region of the substrate 1 in FIG. 7, is configured as an NTC thermistor. In particular, the second functional ceramic 2 is an NTC temperature sensor. The substrate 1 has a thermal contact 11. The thermal contact 11 is conductively connected to the second functional ceramic 2. The thermal contact 11 is configured, for example, in the form of a via/plated-through hole. The plated-through hole extends from the top side of the substrate 1 as far as the second functional ceramic 2.

By virtue of the complete embedding of the functional ceramics 2 into the inert dielectric ceramic carrier (substrate 1), functional ceramics 2 having totally different properties, such as sintering temperature and coefficient of expansion, for example, can be jointly integrated into the substrate 1. Extremely adaptive and flexibly usable multi-layered components 100 can thus be realized.

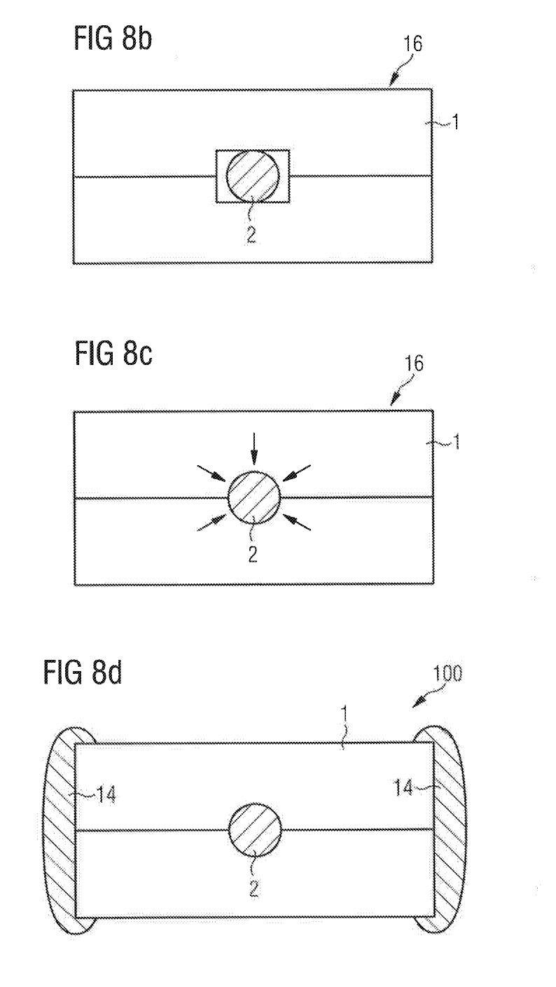

A method for producing a multi-layered component 100 is described below in association with FIGS. 8a to 8d. All features that have been explained for the multi-layered components 100 in association with FIGS. 1 to 7 also find application for the method, and vice versa.

A first step involves producing at least one functional ceramic 2. Preferably, a plurality of, different, functional ceramics 2 are produced, depending on the specific requirements for the multi-layered component 100. Depending on the purpose of use of the respective functional ceramic 2, the production thereof can be very different. What all the functional ceramics 2 have in common is that they are sintered prior to being introduced into the substrate 1.

By way of example, for the production of the functional ceramic 2, ceramic powder is made available and doped with dopants, for example, ZnO. The powder is then sintered. This is carried out at temperatures of greater than or equal to 1000° C. and less than or equal to 1300° C., for example, at 1100° C. This process results in a functional ceramic 2 in the form of a fintered grain, which finds application, for example, as an SMD varistor.

If a varistor chip is intended to be formed as functional ceramic 2, then for its production granules composed of—as described above—sintered grains are provided, sieved and pressed. The pressed granules are then sintered (1000° C.≥T≤1300° C.) and processed to form a disk-shaped varistor chip. The varistor chip is then metallized by means of sputtering or screen printing.

A next step involves providing LTCC green sheets for forming the substrate 1. The green sheets contain, for example, a ceramic powder, a binder and a glass portion. The green sheets 15 are stacked one above another to form a stack. By laser removal or stamping, at least one cutout 6 is introduced into the green layers 15. The cutout serves to introduce the functional ceramic 2 into the green stack 16 in a later method step. In this case, the number of cutouts 6 introduced into the green layers 15 corresponds to the number of functional ceramics 2 in the finished multi-layered component 100.

A further step involves providing, for example, printing, metal structures for forming the internal electrodes 4 on at least one portion of the green sheets 15. In this case, the metal structures are preferably applied before the green sheets 15 provided are stacked together. The metal structures comprise, for example, Ag, Cu, Pd or a combination thereof. The metal structures can be specifically shaped in particular in a connection region for connecting the functional ceramic 2, as has been described in association with FIGS. 4 and 5.

The at least one functional ceramic 2 is then introduced into the cutout 6 (FIG. 8a). In this case, the cutout 6 is equipped with the functional ceramic 2 and the latter is then shaken in.

A further step involves providing ceramic cover sheets 13 in the green state (FIG. 8a). These are arranged at the top side and underside of the stack composed of green sheets 15. The cover sheets 13 are free of the cutout 6, such that the functional ceramic 2 is now surrounded by ceramic material from all sides. This is followed by laminating and pressing the green sheets 13, 15 to form a green stack 16 (FIG. 8b).

Further cutouts for producing the plated-through holes 7 are introduced into the green sheets 13, 15 by means of stamping or laser processes. These cutouts completely penetrate through the green stack 16 composed of the green sheets 15 and the cover sheets 13. In order to produce the respective plated-through hole 7, the cutout is filled with a connecting material after a sintering step, for example, by the deposition of a metal from a solution. Preferably, the cutout is completely filled in the process. The metal contains or is, for example, copper, silver and/or palladium.

A further step involves sintering the green stack 16 (FIG. 8c). The green stack 16 is sintered at a temperature which is below the sintering temperature of the functional ceramic 2. By way of example, the sintering temperature of the green stack is 150° C. below the sintering temperature for the functional ceramic 2. By way of example, the sintering temperature is between 750° C. and 900° C., inclusive of the limits. Preferably, the sintering of the green stack 16 is carried out at 800° C. or 850° C. As a result of the firing of the LTCC ceramic at temperatures significantly below 1000° C., the grain structure of the functional ceramic 2 is no longer influenced. The functionality of the functional ceramic 2 can thus largely be maintained through a suitable choice of the LTCC ceramic and the sintering implementation (atmosphere).

The sintering results in a shrinkage of the green sheets 13, 15. In this case, the suitable selection of the LTCC ceramic with defined shrinkage in the z-direction and little shrinkage in the x- and y-directions makes it possible for the functional ceramic 2 to be enclosed in a manner free of cracks.

A last step involves providing the external contacts 5 at outer surfaces of the sintered green stack 16. By way of example, in this case a silver paste 14 is arranged on at least one partial region of the outer surfaces (FIG. 8d) and then fired.

The description of the subjects specified here is not restricted to the individual specific embodiments. Rather, the features of the individual embodiments can be combined with one another—insofar as is technically expedient—in any desired manner.

1-13. (canceled)

14. A multi-layered component comprising:
an inert ceramic substrate; and
at least one functional ceramic,
wherein the functional ceramic is completely enclosed by the ceramic substrate.

15. The multi-layered component according to claim 14, wherein the ceramic substrate comprises an LTCC ceramic.

16. The multi-layered component according to claim 14, wherein the multi-layered component comprises a plurality of functional ceramics.

17. The multi-layered component according to claim 16, wherein the functional ceramics have different coefficients of expansion and/or different sintering temperatures.

18. The multi-layered component according to claim 14, wherein the at least one functional ceramic comprises an HTCC ceramic.

19. The multi-layered component according to claim 14, wherein the functional ceramic comprises a varistor, an NTC ceramic, a PTC ceramic or a ferrite.

20. The multi-layered component according to claim 14, wherein the ceramic substrate comprises internal electrodes for electrically contacting the functional ceramic.

21. The multi-layered component according to claim 20,
wherein the ceramic substrate comprises a cutout in which the functional ceramic is arranged, and
wherein the internal electrodes extend as far as an edge of the cutout.

22. The multi-layered component according to claim 20,
wherein the functional ceramic comprises external contacts being formed at outer surfaces of the functional ceramic, and
wherein the internal electrodes are electrically conductively connected to the external contacts.

23. The multi-layered component according to claim 20,
wherein external electrodes are arranged at opposite side surfaces of the ceramic substrate for electrically contacting the multi-layered component, and
wherein the external electrodes are electrically connected alternately to the internal electrodes of a different polarity.

24. The multi-layered component according to claim 20, wherein the internal electrodes respectively have a constriction in a region of a feed to the functional ceramic.

25. The multi-layered component according to claim 20, wherein the internal electrodes respectively have a web or a web-shaped connection region for electrically contacting the functional ceramic.

26. The multi-layered component according to claim 14, wherein the functional ceramic is configured as an ESD protection element.

27. The multi-layered component according to claim 20, the multi-layered component comprising:
an LED,
wherein the ceramic substrate comprises external contacts for electrically contacting the multi-layered component, and
wherein the LED is electrically conductively connected to the external contacts of the ceramic substrate.

28. The multi-layered component according to claim 27,
wherein the ceramic substrate comprises plated-through holes completely penetrating through the ceramic substrate,
wherein the plated-through holes respectively are electrically conductively connected to one of the external contacts, and
wherein the internal electrodes respectively are electrically conductively connected to the plated-through holes.

29. The multi-layered component according to claim 20,
wherein a first functional ceramic and a second functional ceramic are embedded in the ceramic substrate and are spatially separated from one another,
wherein the first functional ceramic is configured as a varistor chip, and
wherein the second functional ceramic is configured as an NTC thermistor.

30. The multi-layered component according to claim 29,
wherein the ceramic substrate has a thermal contact comprising a plated-through hole, and
wherein the plated-through hole extends from a top side of the ceramic substrate as far as the second functional ceramic.

31. A method for producing a multi-layered component, the method comprising:
providing LTCC green sheets having at least one cutout;
providing electrode structures on at least one portion of the green sheets;
introducing at least one functional ceramic into the cutout;
providing cover sheets in a green state;
laminating and pressing the green sheets to form a green stack;
sintering the green stack; and
providing external contacts at outer surfaces of the sintered green stack.

32. The method according to claim 31, wherein the at least one cutout is provided by stamping or laser treating the green sheets.

33. The method according to claim 31, further comprising providing spray granules, ceramic powder and/or green layers for producing the functional ceramic, wherein the spray granules, the ceramic powder and/or the green layers are subsequently sintered.

34. The method according to claim 33, wherein the functional ceramic is sintered at a temperature of greater than or equal to 1000° C.

35. The method according to any of claim 31, wherein the green stack is sintered at a temperature that is below a sintering temperature of the functional ceramic.

36. The method according to claim 31, wherein the green stack is sintered at a temperature of less than or equal to 900° C. and greater than or equal to 750° C.
